(19) United States
(12) Patent Application Publication
(10) Pub. No.: US 2007/0147037 A1
(43) Pub. Date: Jun. 28, 2007

(54) Super slim LCD backlight device using uniforming chamber

(75) Inventor: Tsun-I Wang, Taoyuan Hsien (TW)

Correspondence Address: BACON & THOMAS, PLLC, 625 SLATERS LANE, FOURTH FLOOR, ALEXANDRIA, VA, 22314, US

(73) Assignee: Dynascan Technology Corp., Taoyuan Hsien (TW)

(21) Appl. No.: 11/313,665

(22) Filed: Dec. 22, 2005

(51) Int. Cl. F21V 13/04; F21V 7/05

(52) U.S. Cl. 362/245; 362/235; 362/307; 362/308

(57) ABSTRACT

A backlight device for LCD displays is disclosed herein. The backlight device contains multiple LEDs as light source and a uniforming chamber positioned between the LEDs and the LCD panel. Lights emitted from the LEDs undergo multiple times of total reflection by the inner walls of the uniforming chamber to produce a highly uniform planar light, regardless of the length of their usage period, the differences of LEDs' hues and brightness, and whether some LEDs are failed. The backlight device does not require the diffusion plates and prism plates, which not only reduces cost but also avoids the luminous flux loss. Also, the backlight device could achieve the slimmest thickness without sacrificing cost, heat dissipation, and power consumption.

### BACKGROUND OF THE INVENTION

1. Field of the Invention

The present invention generally relates to backlight devices for liquid crystal displays, and more particularly to backlight devices using light emitting diodes as light source.

2. The Prior Arts

Conventionally, backlight devices or backlight modules for liquid crystal displays (LCDs) or LCD TVs usually utilize a side-edge typed technique with cold cathode fluorescent lamps (CCFLs) or light emitting diodes (LEDs) as light source. Lights emitted from the light source are directed into a side of the light guide plate of a backlight device. The lights are then redirected to shoot out of a light emitting plane of the light guide plate by the diffusion dots configured on a surface of the light guide plate. As the lights pass through the light guide plate with a very significant emitting angle, diffusion plate and prism plate are employed for both uniforming and redirecting purposes so as to improve the uniformity and brightness.

The aforementioned side-edge typed technique has quite a few disadvantages, especially for large-size LCDs. For example, large-size light guide plates are difficult to fabricate by molding; the cost and yield of the light guide plate cannot be improved effectively. In addition, the area of the light entering plane of the light guide plate is too small compared to the LCD's panel area; a uniform planar light is difficult to achieve. Accordingly, most large-size LCDs adopt a direct typed technique. FIG. 1a is a schematic diagram showing a conventional direct typed backlight device using CCFL tubes as light source. As illustrated, the backlight device has multiple CCFL tubes 20 horizontally arranged with a spacing (d) in front of a reflection plate 30 so as to reflect and redirect the lights from the CCFL tubes 20 to the back of the LCD panel 50. A diffusion plate and/or a prism plate 40 is configured at a distance (D) in front of the CCFL tubes 20 so as to diffuse and uniform the lights directly from the CCFL tubes 20. Generally, for a better uniforming effect, the distance (D) and the spacing (d) between CCFL tubes 20 are roughly identical.

LEDs have gradually become the mainstream light source for backlight devices as, on one hand, the mercury vapor contained in the CCFL tubes presents an environmental hazard during fabrication and recycling as well. On the other hand, as LED technologies are advanced rapidly in recent years, LEDs have superior lighting efficiency and cost relative to the CCFL tubes, in addition to their better and easier color and brightness control. FIG. 1b is a schematic diagram showing a conventional direct typed backlight device using LEDs as light source. As illustrated, multiple LEDs 10 are arranged in an array with spacing (d′) in front of the reflection plate 30. These LEDs 10 could all be white-light LEDs, or they could be a combination of red-, green-, and blue-light LEDs. Similarly, a diffusion plate and/or prism plate 40 for uniforming effect is arranged in front of the LEDs 10 at a distance (D′). Again, the distance (D′) and the spacing (d′) between the array of LEDs 10 are roughly identical.

The major drawback for LED-based, direct typed backlight devices is that, as individual LEDs' hues and brightness could not be exactly identical and their responses to environmental factors such as temperature are also different, the differences between their hues and brightness deteriorate as their usage time extends. In other words, the light uniformity of LED-based, direct typed backlight devices would be affected by the variations of some individual LEDs. Even though the diffusion plate could balance out such variations and achieve a uniform planar light, its uniforming effect would be inadequate when one or more LEDs differ from the others up to a certain degree or when they are completely broken down.

Additionally, as the lighting efficiency of LEDs are improved significantly and the light power (or luminous flux) of a LED could reach 100 lumens. For a 42-inch LCD TV that requires a luminance 500 cd/m², the LED-based, direct typed backlight device should deliver 10,000 lumens and therefore requires 100 LEDs whose spacing (d′) would be about 8 cm. This implies that the thickness (D′) of the backlight device has to about 8 cm as well, which is too thick. If the spacing (d′) is reduced so as to shrink the thickness (D′), this would have a negative impact on the cost, power consumption, and heat dissipation to the backlight device as there will be a larger number of LEDs arranged densely.

Furthermore, LED-based backlight devices are usually configured with sensors for the backlight devices to detect the brightness and hues of their output lights so as to adjust their driving to the LEDs accordingly. Another drawback of LED-based direct typed backlight devices, therefore, is that the sensors are usually configured at the sides, instead of directly on the paths of the output lights, to avoid blocking the output lights. As such, due to that these sensors are away from the output lights' paths and due to the non-uniformity of output lights, they do not accurately reflect the characteristics of the output lights.

### SUMMARY OF THE INVENTION

Accordingly, the major objective of the present invention is to provide a LED-based backlight device which, on one hand, could shrink the thickness to the minimum without sacrificing cost, heat dissipation, and power consumption and, on the other hand, could deliver a highly uniform planar light regardless of the length of its usage period, the differences of LEDs' hues and brightness, and whether some LEDs are failed.

Another objective of the present invention is that the proposed LED-based backlight device is able to facilitate the configuration of sensors in such a way that they can accurately capture the characteristics of the lights provided by the LED-based backlight device.

To achieve the foregoing objectives, the backlight device provided by the present invention mainly contains multiple LEDs as light source and a uniforming chamber positioned between the LEDs and the LCD panel. Lights emitted from the LEDs undergo multiple reflections by the walls of the uniforming chamber to produce a highly uniform planar light. The planar light is then projected to the back of the LCD panel from a light emitting plane of the chamber.

As the uniforming chamber provides a superior uniforming effect than the conventional diffusion plate, the significantly different hues and brightness of some individual LEDs, despite that the differences would get worse along with their usage time, would be made up to a great extent by the uniforming chamber. A backlight device according to the present invention, therefore, does not requires the installation of diffusion plates and prism plates, which not only reduces cost but also avoids the luminous flux loss (up to 40%˜60%) caused by the diffusion and prism plates. Therefore, a backlight device according to the present invention could be configured with the most appropriate number of LEDs and the slimmest thickness without sacrificing cost, heat dissipation, and power consumption. As the uniforming chamber could be so thin, some embodiments of the present invention actually use a solid transparent plate, instead of a hollow chamber.

Also, as the uniforming chamber provides a superior uniforming effect, the sensors of the proposed LED-based backlight device could be configured at any appropriate locations inside the uniforming chamber to obtain accurate information about the lights projected to the LCD panel without worrying that these sensors might introduce any negative impact to the backlight device.

The foregoing and other objects, features, aspects and advantages of the present invention will become better understood from a careful reading of a detailed description provided herein below with appropriate reference to the accompanying drawings.

### BRIEF DESCRIPTION OF THE DRAWINGS

FIG. 1a is a schematic diagram showing a conventional direct typed backlight device using CCFL tubes as light source.

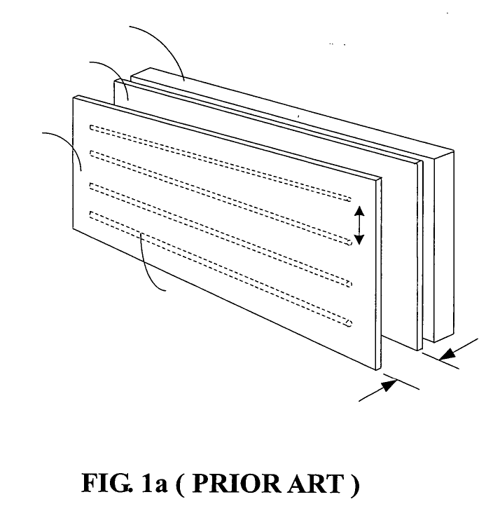

FIG. 1b is a schematic diagram showing a conventional direct typed backlight device using LEDs as light source.

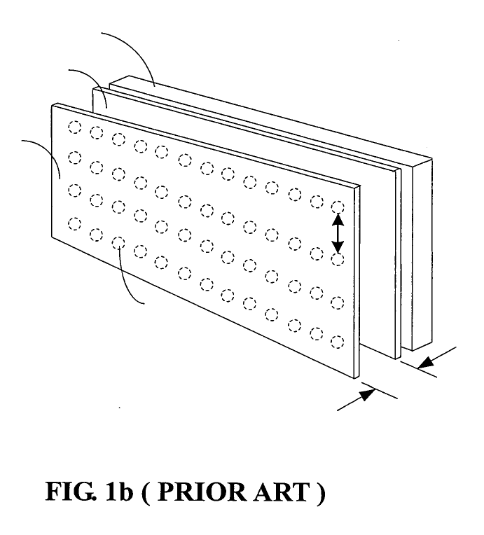

FIG. 2a is a schematic diagram showing a backlight device according to a first embodiment of the present invention.

FIG. 2b is a schematic diagram showing the operation of the uniforming chamber of the backlight device of FIG. 2a.

FIG. 2c is a schematic diagram showing the horizontal traveling distance of a light as it undergoes multiple total reflections inside the uniforming chamber of FIG. 2a.

FIG. 3a is a schematic diagram showing a backlight device according to a second embodiment of the present invention.

FIG. 3b is a schematic diagram showing the operation of the uniforming chamber of the backlight device of FIG. 3a.

FIG. 3c is a schematic diagram showing the light entering or light emitting plane from a top view according to an embodiment of the present invention.

FIG. 3d is a schematic diagram showing the profile of the light entering or light emitting plane according to an embodiment of the present invention.

### DETAILED DESCRIPTION OF THE PREFERRED EMBODIMENTS

A backlight device using LEDs as light source for LCD displays is provided herein. The LCD displays include, but is not limited to, LCD monitors for computers, LCD TVs, and other similar display devices requiring a backlight for illumination.

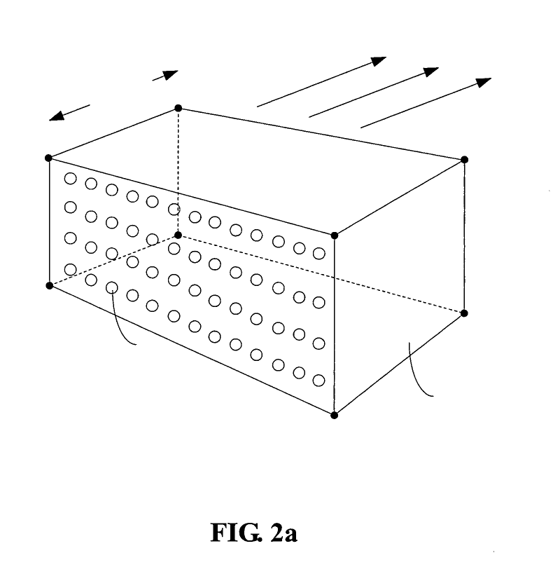

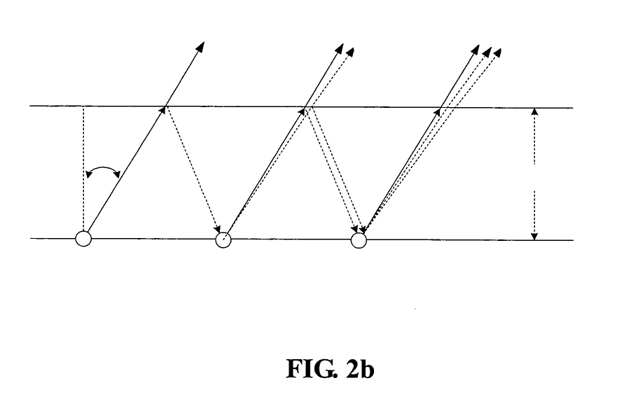

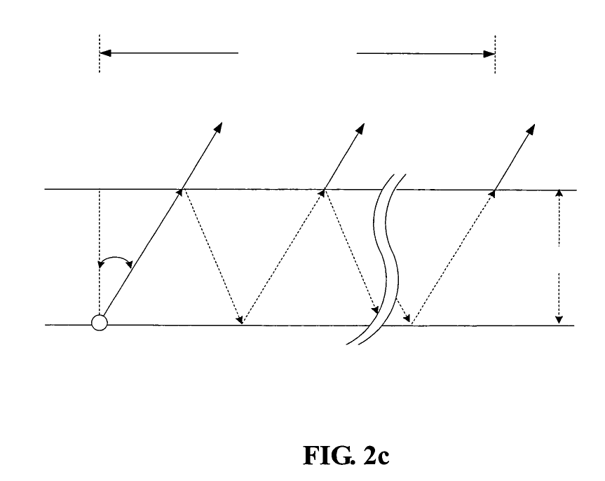

FIG. 2a is a schematic diagram showing a backlight device according to a first embodiment of the present invention. As illustrated, the backlight device at least contains multiple LEDs 10 as a light source and a uniforming chamber 20 positioned between the LEDs 10 and the LCD panel (not shown). Please note that the LEDs 10 could be all white-light LEDs, or could contain red-, green-, and blue-light LEDs, or could be partly white-light LEDs and partly red-, green-, and blue-light LEDs, or any appropriate combination of colored LEDs. The LEDs 10 could be arranged in an array with regular spacing, or the LEDs 10 could be grouped (e.g., one red-light, one blue-light, and two green-light LEDs a group) and the groups are arranged in an array with regular spacing, or the LEDs 10 could be arranged in any appropriate manner. In other words, the present invention does not require the LEDs 10 to have any specific color combination or location arrangement. As to the total number of LEDs 10, it is dependent on the required luminance of the LCD panel.

As illustrated in FIG. 2a, the uniforming chamber 20 is a hollow cube formed by six planes. The LEDs 10 are arranged in close proximity to the E-F-G-H plane (hereinafter, the light entering plane). Lights after being processed by the uniforming chamber 20 are projected out (as indicated by the arrow heads in the diagram) from the chamber 20 via the A-B-C-D plane (hereinafter, the light emitting plane). The light emitting plane directly faces the back of the LCD panel. The light entering plane and the light emitting plane are two parallel planes opposing to each other at a distance (D″). Please note that what is shown in FIG. 2a is only exemplary. The form factor of the chamber 20 is not limited to cube only and, for example, there could be more than one light entering plane. The major function of the uniforming chamber 20 is that the lights emitted by the LEDs 10 are uniformed by multiple reflections inside the uniforming chamber 20 and then projected out through the light emitting plane onto the back of the LCD panel. Any form factor of the uniforming chamber 20 and any arrangement of the light entering and emitting planes that could reach the foregoing function could be considered to be within the scope of the present invention.

The inner wall (i.e., the wall facing toward the inside of the uniforming chamber 20) of the light entering plane is completely coated with a full-spectrum, total reflection film (e.g., the Vikuiti™ DESR-M reflection film manufactured by 3M® whose reflectivity is up to 98-99% within the visible light band). The light entering plane has multiple through holes (not shown) positioned correspondingly to the LEDs 10 so as to allow the lights from LEDs 10 to enter the uniforming chamber 20. Since a portion of the lights, during their undergoing multiple total reflections inside the chamber 20, would be lost by evading out of the chamber 20 via the through holes, the ratio (1) between total area of the through holes and the area of the light entering plane should be as small as possible (e.g., <1%). Taking a 42-inch LCD display as example, assuming that the light entering plane has an area 5000 cm² and 400 LEDs 10 are used as light source (therefore, there are 400 through holes on the light entering plane) and the (1) value is less than 1%, the aperture of each through hole has to be less than 3 mm. Please note that, in some embodiments, the LEDs 10 are actually arranged on the inner wall of the light entering plane to avoid having through holes on the light entering plane. There are also some embodiments in which the light entering plane is a circuit board coated with the total reflection film with the LEDs 10 installed or grown directly on the circuit board.

In addition to the light entering and emitting planes, the rest four planes of the uniforming chamber 20, namely the A-E-H-D plane, the A-B-F-E plane, the B-C-G-F plane, and the C-D-H-G plane all have their inner walls completely coated with identical or similar high reflective full-spectrum, total reflection films, so as to become total reflection surfaces.

The light emitting plane is a so-called partial transmission plane which means that a portion of the lights heading toward the light emitting plane would penetrate through and the rest would be reflected or absorbed by the light emitting plane. Those penetrating through the light emitting plane become the planar light provided to the LCD panel, while those being reflected return to the inside of the uniforming chamber 20, continue to undergo multiple total reflections with the other lights. Those being absorbed would be a loss to the backlight device and therefore should be minimized as much as possible.

FIG. 2b is a schematic diagram showing the operation of the uniforming chamber of the backlight device of FIG. 2a. As shown, a beam of light emitted from LED (1) propagates to the point (P) on the light emitting plane. A portion of the light beam penetrates through the light emitting plane, which is denoted as a light beam (1′), while another portion of the light beam is reflected twice and then reaches the point (Q) on the light emitting plane. Again, a portion of it penetrates through the light emitting plane, which is denoted as a light beam (1″), which is then mixed with a light beam (2′) emitted from LED (2) and penetrates through the light emitting plane at the point (Q), and the process would continue in this fashion so that the light beams (1′″), (2″), and (3′) from LED (1), (2), and (3) respectively are mixed at the point (R). As such, mixing and uniforming lights from multiple LEDs are achieved.

The partial transmission rate (t) of the light emitting plane is defined as the ratio between the portion of lights penetrating through the light emitting plane to the lights directed toward said light emitting plane. Then, the smaller the partial transmission rate (t) is, the lights inside the uniforming chamber 20 would undergo more times of total reflections, which leads to an even better uniforming effect. However, as it is inevitable that some portion of the lights would be absorbed during this process, too many times of total reflections would reduce the effective light emission of the backlight device. The effective light emission rate would be defined as follows, based on the optics law of total reflection:

$$T = \frac{t}{1 - ( 1 - t ) {r}_{1} {r}_{2}} \qquad ( 1 )$$

where (T) is the total effective light emission rate, (r₁) is the reflection rate for the portion of the lights being reflected by the light emitting plane, and (r₂) is the effective reflection rate of the light entering plane. From equation (1), when both the light entering and emitting planes are ideal total reflection surfaces (i.e., (r₁)=(r₂)=1), The total effective light emission rate (T) would be 100%. However, when (t)=10% and (r₁)=(r₂)=0.99, the total effective light emission rate (T) would be about 84%, implying that there are about 16% of lights are lost to absorption.

Similarly, based on the law of optics, the light emission rate for lights at the nth penetration of the light emitting plane is:
tₙ=(1−t)ⁿ⁻¹(r₁r₂)ⁿ⁻¹t (2)
From equation (2), if t=t₁=10%, t₆=0.9⁵(0.99×0.99)⁵×0.1=5%, which means that lights penetrating through at the 6^{th} times is only one half (i.e., 5%/10%=0.5) of the lights penetrating through for the first time. Therefore, the effectiveness of the uniforming effect would decrease as the number of times of the total reflections increases. The power of the lights penetrating through at the nth time could be expressed as P₀×cos θₙ×tₙ, assuming that chip-type LEDs are used and the full half-power angle is 120°, where P₀ is the power of axial lights emitted from the LEDs, and θₙ is defined as the effective uniforming angle of the lights when they penetrate the light emitting plane for the nth time. If the effective uniforming range is defined as when the power of the lights penetrating through for the nth time is 37% (i.e., about e⁻¹) of the lights axially penetrating through for the first time (i.e., n=1 and θ₁=0°), then the following equation could be derived:
P₀×cos θₙ×tₙ=0.37×P₀×cos θ₁=0.37×P₀×t₁
With t₁=10% and t₆=5%, the equation becomes
P₀×cos θ₆×0.05=0.37×P₀×0.1
And θ₆ is derived to be about 42°. The horizontal distance L₆ (please refer to FIG. 2c) is defined as effective uniforming range that the lights have traveled when they penetrate through the light emitting plate for the 6^{th} time could be derived as follows:
L₆=11×D″×tan θ₆≈10×D″ (3)
If the depth D″ of the uniforming chamber 20 is designed to be 2 cm, the uniforming range L₆ is about 20 cm and that means a LED would therefore cover a circular area about 1300 cm² with a radius about 20 cm. If a 42-inch LCD display has a panel area bout 5000 cm², a single LED could cover 26% of the panel area.

Using the foregoing 42-inch LCD display as example, its backlight device has to provide 10,000 lumens in order to support the required 500 cd/m² effective luminance. If a single LED is capable of providing 100 lumens, the backlight device would require totally about 100 LEDs. If the backlight device is a conventional direct typed backlight device and the spacing d′ between LEDs should be about 8 cm, the depth D′ of the backlight device is also about 8 cm. In contrast, a backlight device according to the present invention could have its depth D″ shrunk down to 2 cm. From the above calculations, each LED has a coverage about 1300 cm² and, therefore, there are about 26 LEDs within this area. In other words, each LED has its lights uniformed with the other 25 LEDs and, therefore, a very high degree of uniformity could be achieved. Assuming that one of the LEDs within the area has its brightness degraded for 50%, the brightness of the entire area is affected and degraded for only 1.9% (50%/26).

For a conventional side-edge typed backlight device, since the lights pass through its light guide plate with a very significant emitting angle. A diffusion plate and prism plate are therefore employed for both uniforming and redirecting purposes so as to improve the uniformity and brightness of the planar light the backlight device provides. Another approach for improving the luminous intensity of the conventional direct typed backlight device is to utilize small-angled LEDs. For example, a LED with a full half-power angle 60° has a luminous intensity about three times of a LED with a full half-power angle 120°, even though they are packaged using the same LED die. However, the problem with small-angled LEDs is that their projection area is very small and, therefore, a larger number of LEDs have to be arranged densely with very small spacing therebetween. This inevitably introduces problems such as increased cost and heat dissipation. However, with the uniforming chamber proposed by the present invention, lights from small-angled LEDs could preserve their small-angle characteristic during the multiple total reflections and after their projection out through the light emitting plane while their covering area are effectively enlarged by the multiple total reflections. Assuming that a small-angled LED has a full half-power angle 60°, the LED's directivity profile curve could be roughly described as P₀×cos⁴θ. Then, using the equation P₀×cos⁴θ×0.05=0.37×P₀×0.1, it can be derived that θ₆=22° and L₆=11×D″×tan θ₆=4.4 D″. If D″=3 cm, the effective uniforming range is about 550 cm², which is about 11% of the LCD panel. If the backlight device contains 100 LEDs, there are about 9 LEDs within this area to have their lights uniformed. Assuming that one of the LEDs within the area has its brightness degraded for 50%, the brightness of the entire area is affected and degraded for only 5˜6%. A very high degree of uniformity could still be achieved.

Due to the highly uniforming effect and high directivity of the uniforming chamber, the present invention does not require the use of diffusion and prism plates. The present invention therefore avoids the loss caused by the diffusion and prism plates, which could be up 40%˜50% of the total luminous intensity. In other words, even without the diffusion and prism plates, the backlight device according to the present invention alone could achieve high uniformity and high brightness, in addition to reducing the thickness of the backlight device.

The partial transmission of the “light emitting plane” could be obtained by coating a thin film of aluminum or silver on the inner wall of the “light emitting plane”. If the thickness of the metallic film is thin enough, the film could provide a partially reflective and partial transmission effect, whose partial transmission rate could be controlled by varying the thickness of the metallic film. Another approach is to coat an appropriate non-metallic partial transmission film on the inner wall. Yet another approach is to use the full-spectrum total reflection film configured with multiple through holes with an appropriate density. Then, the partial transmission rate (t) is the ratio between the total area of the through holes and the area of the light emitting plane. Assuming that the holes having a diameter (w) are arranged with a spacing (W), the partial transmission rate of the light emitting plane is πw²/4 W². For example, if W=0.1 mm and t=10%, then the diameter of each through hole is about 0.035 mm. In general, as the spacing (W) gets smaller, the planar light projected from the light emitting plane would be more uniform.

To further reduce the thickness of the backlight device, say, down to 1 cm, L₆ would become about 10 cm according to the above equation (3). If the LEDs are arranged with a spacing 8 cm, there will only be 6.3 LEDs within the effective uniforming range, which obviously cannot provide an adequate uniforming effect. Therefore, the following embodiment of the present invention adopts wave-like light entering plane and wave-like light emitting plane to obtain an even thinner backlight device.

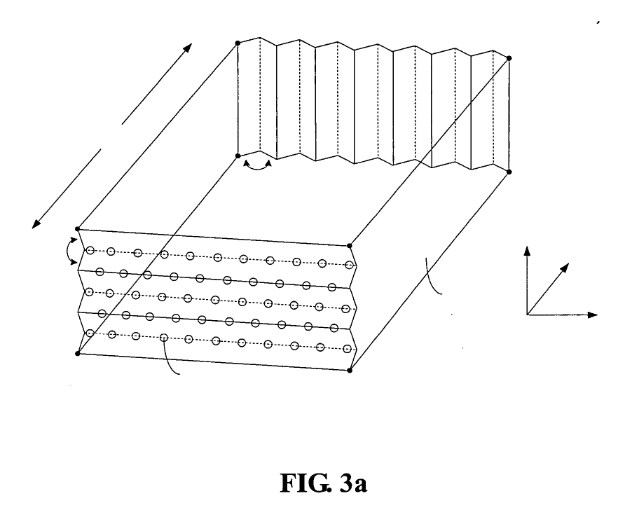

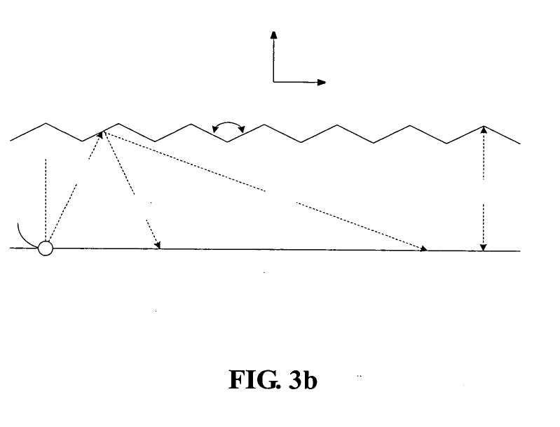

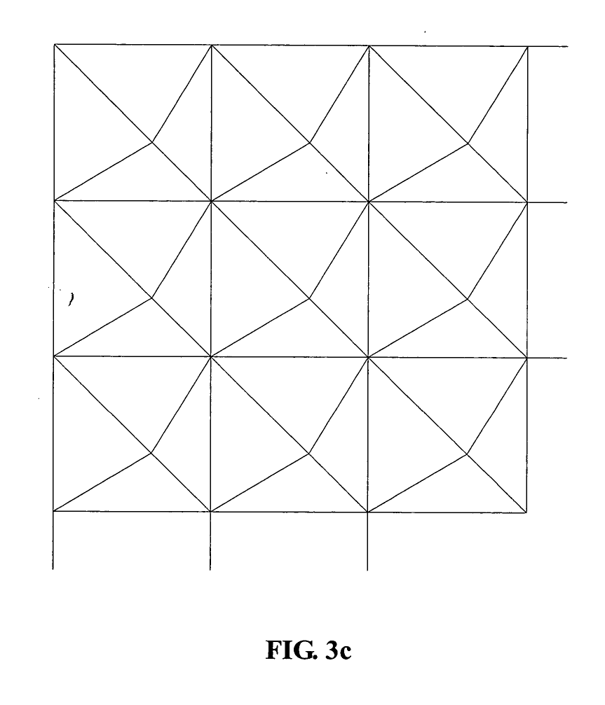

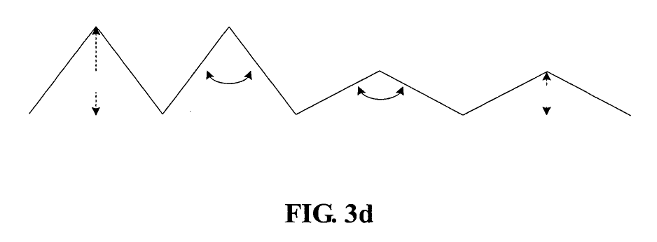

FIG. 3a is a schematic diagram showing a backlight device according to a second embodiment of the present invention. The present embodiment is identical to the previous embodiment with only the following differences: (1) The light emitting plane (i.e., the A-B-C-D plane) contains a series of rectangular planes aligned in parallel with the adjacent planes' sides joined together with an included angle θ₁ between 180° and 90° so that wave-like crests and troughs are formed along the X axis; and (2) The light entering plane (i.e., the E-F-G-H plane) contains a series of rectangular planes aligned in parallel with the adjacent planes' sides joined together with an included angle θ₂ between 180° and 90° so that wave-like crests and troughs are formed along the Y axis. Please note that, when θ₁=θ₂=180°, the present embodiment is identical to the previous embodiment.

FIG. 3b is a schematic diagram showing the operation of the uniforming chamber of the backlight device of FIG. 3a, which is a top view along the Y axis. As illustrated, a LED positioned at a point (O) on the light entering plane issues a light (1) at an angle (φ). When the light (1) reaches a point (R) on the light emitting plane, a portion of it is reflected as a light (3) and reaches a point (Q) on the light entering plane. The distance between the points O and Q (OQ) could be expressed as:
OQ=D*(|tan φ|+|tan(θ₁−φ)
If θ₁=180° (i.e., the previous embodiment), a portion of the light (1) is reflected back to a point (P) on the light entering plane as a light (2), the distance OP could be expressed as:
OP=2D*tan φ
If φ=42° and θ₁=120°, then OQ=5.6 D* and OP=1.8 D* from the above two equations. In other words, the waveform structure of the present invention provides a reflection distance which is 3˜4 times of that of the previous embodiment. Accordingly, after multiple total reflections, the effective uniforming range obtained would also 3˜4 times larges than that of the previous embodiment. Similarly, since the light entering plane also adopts the same waveform structure along the Y axis, the present embodiment would also have 3˜4 times larger reflection distance along the Y axis. Therefore, the effective uniforming range contributed jointly by the lengthening effect of the waveform structures along both the X and Y axes would be 9 times of that obtained from previous embedment. For the same uniforming range, in other words, the depth D* of the present embodiment is only ⅓ of the depth D″ of the previous embodiment. If the previous embodiment has a D″=2 cm, the present embodiment could achieve a depth D* as low as 0.6 cm and, therefore, an extremely thin backlight device is obtained.

Please note that what is shown in FIG. 3a is only exemplary; There are various other configurations of the light entering and emitting planes that could achieve a similar result. For example, (1) the light entering plane has its waveform structure formed along the Y axis, while the light emitting plane has its waveform structure formed along the X axis (i.e., opposite to what is shown in FIG. 3a); (2) the light entering plane is a smooth plane, while the light emitting plane is a combination of the waveform structures of the A-B-C-D and E-F-G-H planes and therefore has crests and troughs both along the X and Y axes as shown in FIG. 3c; (4) the light emitting plane is a smooth plane, while the light entering plane is a combination of the waveform structures of the A-B-C-D and E-F-G-H planes and therefore has crests and troughs both along the X and Y axes as shown in FIG. 3c; and (4) both the light entering and light emitting planes are a combination of the waveform structures of the A-B-C-D and E-F-G-H planes and therefore has crests and troughs both along the X and Y axes as shown in FIG. 3c.

Some other variations of the light entering and emitting planes are shown in FIG. 3d: (1) The included angles θₐ-θ_{b} between adjacent planes forming the crests and troughs are not uniform; and (2) The heights (or depth) Hₐ-H_{b} of the crests (or troughs) are not uniform. The major characteristic of the light entering and emitting planes lies in that waveform structures are used to lengthen the reflection distances along two orthogonal dimensions (i.e., two directions co-planed with the light entering and emitting planes) and, as long as the two dimensions are orthogonal, they are not necessarily the X and Y axes only. In short, the present invention does not require the waveform structures to be formed in any specific configurations.

Please note that, as the uniforming chamber could be so thin, some embodiments of the present invention could use a solid transparent plate, instead of a hollow uniforming chamber as described above. The foregoing operation principles and variations of the hollow uniforming chamber are equally applicable to the solid transparent plate (for example, by replacing the term “inner wall” and “plane” with “surface”). More specifically, the light emitting surface of the solid transparent plate is coated with a partial transmission film while all other surfaces are coated with full-spectrum, total reflection films. As to the LEDs, for example, there could be multiple cavities on the light entering surface for accommodating the LEDs.

As the lights are uniformed inside the hollow uniforming chamber or the solid transparent plate, a sensor anywhere inside the chamber or the plate would detect approximately identical result. As such, the present invention actually significantly simplifies the configuration of the sensors for the proposed backlight device. In some embodiments, if the uniforming chamber is used, the sensors could be configured at any appropriate locations inside the chamber and there is no need to concern whether lights would be blocked by the sensor. Similarly, in some other embodiments where solid transparent plate is used, the sensors could be placed in cavities configured anywhere on all surfaces except the light emitting surface.

To further enhance the uniforming effect of the uniforming chamber or the transparent plate, a variant to all foregoing embodiments is to replace the full-spectrum, total reflection film or similar mechanism applied to at least an inner wall of the uniforming chamber or at least a surface of the transparent plate with a full-spectrum reflection film with matt surface or a similar mechanism. The rough matt surface of the reflection film would scatter its reflected lights to multiple directions and, thereby, would achieve an even better uniforming effect. Please note that the use of total reflection film and reflection film with matt surface could be jointly applied to the same uniforming chamber or transparent plate.

Although the present invention has been described with reference to the preferred embodiments, it will be understood that the invention is not limited to the details described thereof. Various substitutions and modifications have been suggested in the foregoing description, and others will occur to those of ordinary skill in the art. Therefore, all such substitutions and modifications are intended to be embraced within the scope of the invention as defined in the appended claims.

What is claimed is:

1. A backlight device for a LCD display, comprising:
a plurality of LEDs; and
a uniforming member, said uniforming member comprising at least a light emitting plane and a light entering plane, said light emitting plane facing the back of said LCD display's panel, said light emitting plane allowing a portion of lights passing through from inside said uniforming member;
wherein lights emitted from said LEDs are mixed and uniformed by undergoing a plurality of times of reflections inside said uniforming member, and then projected toward the back of said LCD display's panel via said light emitting plane.

2. The backlight device according to claim 1, wherein said uniforming member is a hollow object comprising a plurality of planes including said light entering plane and said light emitting plane.

3. The backlight device according to claim 1, wherein said uniforming member is a hollow cube formed by six planes; and said light emitting plane and said light entering plane are two parallel and opposing planes of said six planes.

4. The backlight device according to claim 2, wherein said LEDs are positioned outside said uniforming member in close proximity to said light entering plane; said light entering plane has a plurality of through holes located correspondingly to said LEDs respectively; and lights emitted from said LEDs entering said uniforming member via said through holes.

5. The backlight device according to claim 2, wherein said LEDs are positioned on said light entering plane inside said uniforming member, whose lights are emitted toward the inside of said uniforming member.

6. The backlight device according to claim 2, wherein said light entering plane is a circuit board and said LEDs are installed on said circuit board, whose lights are emitted toward the inside of said uniforming member.

7. The backlight device according to claim 2, wherein the inner surface of said plurality of planes except that of said light emitting plane is coated with a reflection film.

8. The backlight device according to claim 2, wherein the inner surface of said light emitting plane is coated with a metallic film of an appropriate thickness so as to provide partial transmission.

9. The backlight device according to claim 2, wherein said the inner surface of said light emitting plane is coated with a non-metallic partial transmission film so as to provide partial transmission.

10. The backlight device according to claim 2, wherein said the inner surface of said light emitting plane is coated with a reflection film having a plurality through holes of an appropriate aperture so as to provide partial transmission.

11. The backlight device according to claim 1, wherein said uniforming member is a solid transparent object comprising a plurality of surfaces, one of said surface is said light entering plane, and another one of said surfaces is said light emitting plane.

12. The backlight device according to claim 1, wherein said uniforming member is a solid cube comprises six surfaces; and said light emitting plane and said light entering plane are two parallel and opposing surfaces of said six surfaces.

13. The backlight device according to claim 11, wherein said LEDs are positioned on said light entering plane, whose lights are emitted toward the inside of said uniforming member.

14. The backlight device according to claim 11, wherein said plurality of surfaces except said light emitting plane are coated with a reflection film.

15. The backlight device according to claim 11, wherein said light emitting plane is coated with a metallic film of an appropriate thickness so as to provide partial transmission.

16. The backlight device according to claim 11, wherein said light emitting plane is coated with a non-metallic partial transmission film so as to provide partial transmission.

17. The backlight device according to claim 11, wherein said light emitting plane is coated with a reflection film having a plurality through holes of an appropriate aperture so as to provide partial transmission.

18. The backlight device according to claim 1, wherein said light emitting plane comprises a plurality of rectangular planes aligned in parallel with the adjacent planes' sides joined together with an appropriate included angle so that wave-like crests and troughs are formed along a first direction co-planed with said light emitting plane; and said light entering plane comprises a plurality of rectangular planes aligned in parallel with the adjacent planes' sides joined together with an appropriate included angle so that wave-like crests and troughs are formed along a second direction co-planed with said light entering plane.

19. The backlight device according to claim 18, wherein said first direction and said second direction are orthogonal.

20. The backlight device according to claim 18, wherein said included angle is between 180° and 90°.

21. The backlight device according to claim 1, wherein said light emitting plane comprises a plurality of rectangular planes aligned in parallel with the adjacent planes' sides joined together with an appropriate included angle so that wave-like crests and troughs are formed along a first direction co-planed with said light emitting plane; and said light emitting plane further comprises a plurality of rectangular planes aligned in parallel with the adjacent planes' sides joined together with an appropriate included angle so that wave-like crests and troughs are formed along a second direction co-planed with said light emitting plane.

22. The backlight device according to claim 21, wherein said first direction and said second direction are orthogonal.

23. The backlight device according to claim 21, wherein said included angle is between 180° and 90°.

24. The backlight device according to claim 1, wherein said light entering plane comprises a plurality of rectangular planes aligned in parallel with the adjacent planes' sides joined together with an appropriate included angle so that wave-like crests and troughs are formed along a first direction co-planed with said light entering plane; and said light entering plane further comprises a plurality of rectangular planes aligned in parallel with the adjacent planes' sides joined together with an appropriate included angle so that wave-like crests and troughs are formed along a second direction co-planed with said light entering plane.

25. The backlight device according to claim 24, wherein said first direction and said second direction are orthogonal.

26. The backlight device according to claim 24, wherein said included angle is between 180° and 90°.

27. The backlight device according to claim 2, further comprising a plurality of sensors for detecting characteristics of lights emitted from said LEDs, said sensors configured at appropriate locations inside said hollow object.

28. The backlight device according to claim 11, further comprising a plurality of sensors for detecting characteristics of lights emitted from said LEDs, said sensors configured on all surfaces except the surface of said light emitting plane.

29. The backlight device according to claim 2, wherein the inner surface of at least one of said plurality of planes is coated with a reflection film with matt surface.

30. The backlight device according to claim 29, wherein said light emitting plane is coated with said reflection film with matt surface and said reflection film with matt surface has a plurality through holes of an appropriate aperture so as to provide partial transmission.

31. The backlight device according to claim 11, wherein at least one of said plurality of surfaces is coated with a reflection film with matt surface.

32. The backlight device according to claim 11, wherein said light emitting plane is coated with said reflection film with matt surface and said reflection film with matt surface has a plurality through holes of an appropriate aperture so as to provide partial transmission.
